(19) United States
(12) Patent Application Publication
(10) Pub. No.: US 2014/0215471 A1
(43) Pub. Date: Jul. 31, 2014

(54) CREATING A MODEL RELATING TO EXECUTION OF A JOB ON PLATFORMS

(71) Applicant: HEWLETT- PACKARD DEVELOPMENT COMPANY, L.P., Houston, TX (US)

(72) Inventors: Ludmila Cherkasova, Sunnyvale, CA (US); Abhishek Verma, Champaign, IL (US)

(73) Assignee: HEWLETT-PACKARD DEVELOPMENT COMPANY, L.P., Houston, TX (US)

(21) Appl. No.: 13/751,262

(22) Filed: Jan. 28, 2013

(51) Int. Cl. G06F 9/48

(52) U.S. Cl. 718/102

(57) ABSTRACT

At least one benchmark is determined. The at least one benchmark is run on first and second computing platforms to generate platform profiles. Based on the generated platform profiles, a model is generated that characterizes a relationship between a MapReduce job executing on the first platform and the MapReduce job executing on the second platform, wherein the MapReduce job includes map tasks and reduce tasks.

### BACKGROUND

An enterprise can gather a variety of data, such as data gathered from social websites, data from log files relating to visits of a website, data collected by sensors, financial data, and so forth. A MapReduce framework can be used to develop parallel applications for processing relatively large amounts of different data. A MapReduce framework provides a distributed arrangement of machines to process requests with respect to data.

A MapReduce job can include map tasks and reduce tasks that can be executed in parallel by multiple machines. The performance of a MapReduce job generally depends upon the configuration of the cluster of machines, and also based on the size of an input dataset.

### BRIEF DESCRIPTION OF THE DRAWINGS

Some embodiments are described with respect to the following figures:

FIG. 1 is a block diagram of an example arrangement that incorporates some implementations;

FIG. 2 is a flow diagram of a model creation process according to some implementations; and

FIG. 3 is a schematic diagram of benchmarks and benchmark specifications, according to further implementations.

### DETAILED DESCRIPTION

Generally, a MapReduce system includes a master node and multiple slave nodes (also referred to as worker nodes). An example open-source implementation of a MapReduce system is a Hadoop system. A MapReduce job submitted to the master node is divided into multiple map tasks and multiple reduce tasks, which can be executed in parallel by the slave nodes. The map tasks are defined by a map function, while the reduce tasks are defined by a reduce function. Each of the map and reduce functions can be user-defined functions that are programmable to perform target functionalities. A MapReduce job thus has a map stage (that includes map tasks) and a reduce stage (that includes reduce tasks).

MapReduce jobs can be submitted to the master node by various requestors. In a relatively large network environment, there can be a relatively large number of requestors that are contending for resources of the network environment. Examples of network environments include cloud environments, enterprise environments, and so forth. A cloud environment provides resources that are accessible by requestors over a cloud (a collection of one or multiple networks, such as public networks). An enterprise environment provides resources that are accessible by requestors within an enterprise, such as a business concern, an educational organization, a government agency, and so forth.

Although reference is made to a MapReduce framework or system in some examples, it is noted that techniques or mechanisms according to some implementations can be applied in other distributed processing frameworks that employ map tasks and reduce tasks. More generally, “map tasks” are used to process input data to output intermediate results, based on a specified map function that defines the processing to be performed by the map tasks. “Reduce tasks” take as input partitions of the intermediate results to produce outputs, based on a specified reduce function that defines the processing to be performed by the reduce tasks. The map tasks are considered to be part of a map stage, whereas the reduce tasks are considered to be part of a reduce stage.

A MapReduce system can process unstructured data, which is data that is not in a format used in a relational database management system. Although reference is made to unstructured data in some examples, techniques or mechanisms according to some implementations can also be applied to structured data formatted for relational database management systems.

Map tasks are run in map slots of slave nodes, while reduce tasks are run in reduce slots of slave nodes. The map slots and reduce slots are considered the resources used for performing map and reduce tasks. A “slot” can refer to a time slot or alternatively, to some other share of a processing resource or storage resource that can be used for performing the respective map or reduce task.

More specifically, in some examples, the map tasks process input key-value pairs to generate a set of intermediate key-value pairs. The reduce tasks produce an output from the intermediate results. For example, the reduce tasks can merge the intermediate values associated with the same intermediate key.

The map function takes input key-value pairs (k₁, v₁) and produces a list of intermediate key-value pairs (k₂, v₂). The intermediate values associated with the same key k₂ are grouped together and then passed to the reduce function. The reduce function takes an intermediate key k₂ with a list of values and processes them to form a new list of values (v₃), as expressed below.

map(k₁,v₁)→list(k₂,v₂)

reduce(k₂,list(v₂))→list(v₃).

The reduce function merges or aggregates the values associated with the same key k₂. The multiple map tasks and multiple reduce tasks are designed to be executed in parallel across resources of a distributed computing platform that makes up a MapReduce system.

The lifecycle of a computing platform (which can include hardware and machine-readable instructions), such as a computing platform used to implement a MapReduce system, is in a range of some number of years, such as three to five years, for example. After some amount of time, an existing computing platform may have to be upgraded to a new computing platform, which can have a different configuration (in terms of a different number of computing nodes, different number of processors per computing node, different numbers of processor cores per processor, different types of hardware resources, different types of machine-readable instructions, and so forth) than the existing computing platform.

Human information technology (IT) personnel may be involved in making the decision regarding choices relating to the configuration of the new computing platform. In some cases, the decision process may be a manual process that can be based on guesses made by the IT personnel. There can be a relatively large set of different configuration choices that the IT personnel can select for the new computing platform.

In some cases, the IT personnel may select the configuration of the new computing platform based on general specifications associated with components (e.g. processors, memory devices, storage devices, etc.) of a computing platform. However, predicting performance of a new computing platform based on general specifications of platform components may not accurately capture actual performance of the new computing platform when executing production MapReduce jobs. A production job can refer to a job that is actually executed or used by an enterprise (e.g. business concern, government agency, educational organization, individual, etc.) as part of the normal operation of the enterprise.

The intricate interaction of processors, memory, and disks, combined with the complexity of the execution model of a MapReduce system (e.g. Hadoop system) and layers of machine-readable instructions (e.g. Hadoop Distributed File System (HDFS) and other software or firmware) may make it difficult to predict the performance of a computing platform based on assessing the performance of underlying components.

In accordance with some implementations, techniques or mechanisms are provided to allow for more accurate prediction of a performance of a MapReduce job on a target computing platform. The target computing platform (for implementing a MapReduce system) can be a new computing platform that is different from an existing computing platform. The new computing platform can be selected as an upgrade from the existing computing platform (which is currently being used to execute production MapReduce jobs).

A model (also referred to as a “prediction model” or “comparative model”) can be created that characterizes a relationship between a MapReduce job executing on an existing computing platform and the MapReduce job executing on the target computing platform. As discussed further below, creation of the model can be based on platform profiles generated from running benchmarks on the respective existing and new platforms. The model can be used to determine performance of a production MapReduce job on the new computing platform, given the performance of the production MapReduce job on the existing computing platform.

More generally, instead of a model that characterizes a relationship between an existing computing platform and a new computing platform, the model can characterize a relationship between a first computing platform and a second computing platform. In some cases, it is noted that the first and second computing platforms may both be new alternative computing platforms that have not yet been used to execute production MapReduce jobs. Thus, in this latter example, the comparison is not between an existing computing platform and a new computing platform, but between two new computing platforms.

The model that characterizes the relationship between the first and second computing platforms can be considered a comparative model to allow for more accurate prediction of relative performance of MapReduce jobs on the first and second computing platforms.

The predicted performance of MapReduce jobs on a computing platform can include a predicted completion time of the MapReduce job. The completion time can include a length of time, or an absolute time by which the MapReduce job can complete. In other examples, other types of performance metrics can be determined for characterizing the performance of MapReduce jobs on computing platforms.

In accordance with some implementations, the model used to characterize a relationship between first and second computing platforms can model various phases of map tasks and various phases of reduce tasks. The ability to model phases of a map task and phases of a reduce task allows for more accurate determination of predicted performance on a computing platform for executing MapReduce jobs.

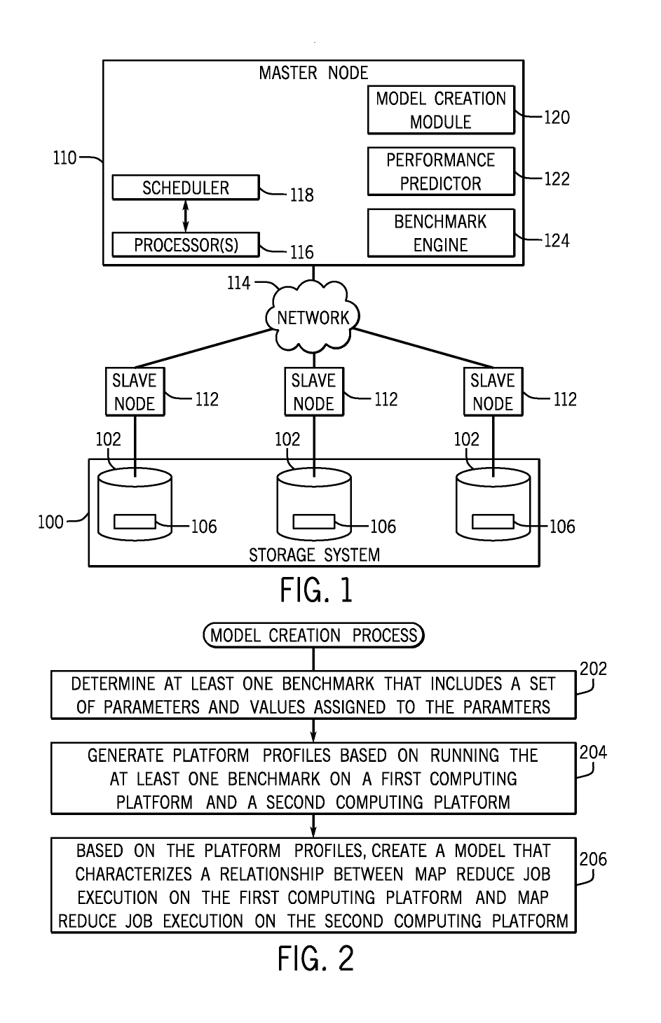

FIG. 1 illustrates an example arrangement that includes a distributed MapReduce framework according to some examples. As depicted in FIG. 1, a storage subsystem 100 includes multiple storage modules 102, to store data. The storage modules 102 can store segments 106 of data across the multiple storage modules 102. The storage modules 102 can also store outputs of map and reduce tasks.

The storage modules 102 can be implemented with storage devices such as disk-based storage devices or integrated circuit or semiconductor storage devices. In some examples, the storage modules 102 correspond to respective different physical storage devices. In other examples, multiple ones of the storage modules 102 can be implemented on one physical storage device, where the multiple storage modules correspond to different logical partitions of the storage device.

The system of FIG. 1 further includes a master node 110 that is connected to slave nodes 112 over a network 114. The network 114 can be a private network (e.g. a local area network or wide area network) or a public network (e.g. the Internet), or some combination thereof. The master node 110 includes one or multiple processors 116. Each slave node 112 also includes one or multiple processors (not shown). Although the master node 110 is depicted as being separate from the slave nodes 112, it is noted that in alternative examples, the master node 110 can be one of the slave nodes 112.

A “node” refers generally to processing infrastructure to perform computing operations. A node can refer to a computer, or a system having multiple computers. Alternatively, a node can refer to a CPU within a computer. As yet another example, a node can refer to a processing core within a CPU that has multiple processing cores. More generally, the system can be considered to have multiple processors, where each processor can be a computer, a system having multiple computers, a CPU, a core of a CPU, or some other physical processing partition.

A computing platform (or a computing cluster) that is used to execute map tasks and reduce tasks includes the slave nodes 112 and the respective storage modules 102.

Each slave node 112 has a corresponding number of map slots and reduce slots, where map tasks are run in respective map slots, and reduce tasks are run in respective reduce slots. The number of map slots and reduce slots within each slave node 112 can be preconfigured, such as by an administrator or by some other mechanism. The available map slots and reduce slots can be allocated to the jobs.

The slave nodes 112 can periodically (or repeatedly) send messages to the master node 110 to report the number of free slots and the progress of the tasks that are currently running in the corresponding slave nodes.

In accordance with some implementations, a scheduler 118 in the master node 110 is configured to perform scheduling of MapReduce jobs on the slave nodes 112. The master node 110 can also include a model creation module 120, which can be used to create a model that characterizes a relationship MapReduce job execution on a first computing platform (such as the platform depicted in FIG. 1) and a second computing platform (which can be another computing platform that is being compared to the first computing platform).

The model created by the model creation module 120 can be used by a performance predictor 122 to predict a performance of the target computing platform. Additionally, the master node 110 includes a benchmark engine 124 that is used to generate benchmarks (discussed further below) that can be used by the model creation module 120 to create models.

The scheduler 118, model creation module 120, performance predictor 122, and benchmark engine 124 can be implemented as machine-readable instructions executable on one or multiple processors 116.

Although the model creation module 120, performance predictor 122, and benchmark engine 124 are depicted as being part of the master node 110 in FIG. 1, it is noted that the model creation module 120, performance predictor 122, and benchmark engine 124 can be implemented on separate computer system(s) in other examples.

FIG. 2 is a flow diagram of a process of creating a model according to some implementations. The process of FIG. 2 can be performed by the model creation module 120 and benchmark engine 124 of FIG. 1, for example. The benchmark engine 124 determines (at 202) at least one benchmark that includes a set of parameters and values assigned to the respective parameters. The parameters of the benchmark can characterize a size of input data, and various characteristics associated with map and reduce tasks. A benchmark can also be referred to as a synthetic microbenchmark. The benchmark can be considered to profile execution phases of a MapReduce job. Each benchmark can use randomly generated data. In some implementations, the determining task (202) of FIG. 2 can produce multiple benchmarks.

In some implementations, the at least one benchmark that is determined (at 202) is based on a production MapReduce job. In other implementations, the benchmark can be created in the absence of a production job. This can be in the context where IT personnel may be comparing alternative new computing platforms to select. Since the new computing platforms have not yet been deployed, a production job has not yet run on the alternative new computing platforms.

The model creation module 120 generates (at 204) platform profiles based on running the at least one benchmark on a first computing platform and on a second computing platform that is being considered as an upgrade from the existing platform. The platform profiles can each include durations of various phases associated with map and reduce tasks. Additional discussion of these various phases are discussed further below.

Based on the generated platform profiles, the model creation module 120 creates (at 206) a model that characterizes a relationship between a MapReduce job executing on the first platform and the MapReduce job executing on a second platform.

The performance of a phase of a map task or reduce task depends on the amount of data processed in each phase as well as the efficiency of the underlying computing platform involved in this phase. Since performance of a phase can depend upon the amount of data processed, there is no single value of a parameter that can characterize the performance of a phase. However, by running multiple benchmarks on each of the platforms that are considered, a model can be built that more accurately relates the phase execution times of the map and reduce tasks on the platforms.

Each benchmark can include specified fixed numbers of map tasks and reduce tasks. The numbers of map and reduce tasks can be relatively low numbers to lessen computation time in the model creation process. Thus, by running benchmarks on the first and second computing platforms (rather than running actual production MapReduce production jobs on the computing platforms), a more efficient process of creating a model can be provided.

In some examples, a benchmark can include the following parameters:
Input data size (Mᵢₙₚ): The parameter Mᵢₙₚ controls the size of input data read by each map task. This parameter controls the amount of read data and affects a read phase duration (discussed further below).
Map computation (M_{comp}): The parameter M_{comp} models the computation performed by a map function. In some examples, the map function computation can be modeled as a simple loop that performs a specified calculation, such as the calculation of nth Fibonacci number (n being some specified number greater than 1) in a Fibonacci series. In other examples, the map function computation can be modeled by another sequence of code for performing a different calculation.
Map selectivity (Mₛₑₗ): The parameter Mₛₑₗ is defined as the ratio of the size of the map task output to the size of the map task input. This parameter controls the amount of data produced as the output of the map task, and therefore affects collect, spill and merge phase durations (discussed further below).
Reduce computation (R_{comp}): The parameter R_{comp} models the computation performed by a reduce function. In some examples, the reduce function computation can be modeled as a simple loop that performs a specified calculation, such as the calculation of nth Fibonacci number. In other examples, the reduce function computation can be modeled by another sequence of code for performing a different calculation.
Reduce selectivity (Rₛₑₗ): The parameter Rₛₑₗ is defined as the ratio of the size of the reduce task output to the size of the reduce task input. This parameter controls the amount of output data written back to the storage subsystem 100, and therefore the parameter affects the write phase duration (explained further below).

In some implementations, a benchmark B is parameterized as:

B=(Mᵢₙₚ,M_{comp},Mₛₑₗ,R_{comp},Rₛₑₗ).

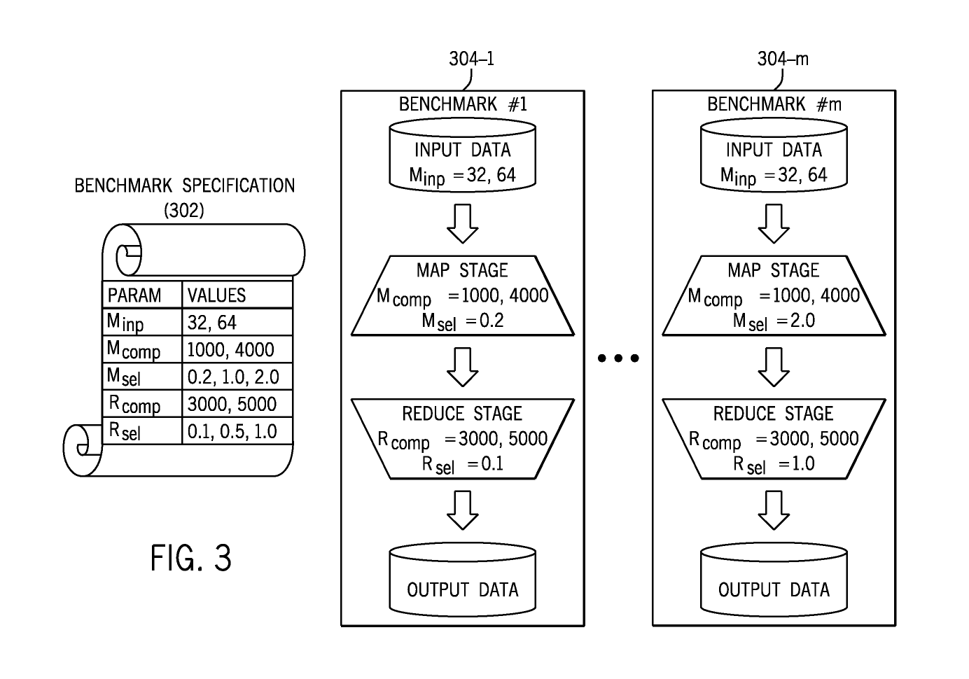

A specific benchmark can be produced by assigning values to respective ones of the parameters listed above in the benchmark B. In some implementations, a range of values can be associated with each of the benchmark parameters. The ranges of benchmark parameters can be specified in a benchmark specification such as a benchmark specification 302 depicted in FIG. 3. The benchmark specification 302 can be supplied from a user or other source (e.g. application, another entity, etc.). The benchmark specification 302 specifies a collection of values for each of the benchmark parameters.

In the example given in FIG. 3, the input data size parameter (Mᵢₙₚ) is associated with the following collection of values: 32, 64 (expressed in terms of gigabytes, terabytes, or some other value). Corresponding collections of values are also associated with the other benchmark parameters in the example benchmark specification 302 given in FIG. 3.

The benchmark engine 124 (FIG. 1) can use the benchmark specification 302 to produce a number of benchmarks 304-1 to 304-m, where m≧2. Each benchmark 304-i (i=1 . . . m) is produced by selecting a unique combination of the possible values for the benchmark parameters as specified in the benchmark specification 302. For example, the benchmark 304-1 uses the value 0.2 for Mₛₑₗ and the value 0.1 for Rₛₑₗ. On the other hand, the benchmark 304-m uses the value 2.0 for Mₛₑₗ and 1.0 for Rₛₑₗ. Thus, in the example of FIG. 3, each benchmark 304-i is created by selecting one value from the collection of candidate values for Mₛₑₗ specified in the benchmark specification 302, and selecting one value from the collection of candidate values for Rₛₑₗ specified in the benchmark specification 302.

The number of benchmarks 304-1 to 304-m that can be produced by the benchmark engine 124 can depend on the number of values specified in the benchmark specification 302 for each of Mₛₑₗ and Rₛₑₗ. In the example of FIG. 3, there are three possible values for each of Mₛₑₗ and Rₛₑₗ. Thus, 9 (3×3) possible benchmarks can be created. More generally, if there are M candidate values in the benchmark specification 302 for Mₛₑₗ and R candidate values in the benchmark specification 302 for Rₛₑₗ, then the number of benchmarks that can be created is M×R. By using the benchmark specification 302, a suite of benchmarks can be easily created, where the benchmarks in the benchmark suite covers useful and diverse ranges across the benchmark parameters.

Each benchmark 304-i depicted in FIG. 3 includes an input data stage, a map stage, a reduce stage, and an output data stage. Within each benchmark 304-i, the size of the input data (Mᵢₙₚ) for each map task can be selected in a round robin (or other) fashion from the collection of values for the Mᵢₙₚ specified in the benchmark specification 302. Similarly, within each benchmark, the value of M_{comp} and the value of R_{comp} can be selected in round robin (or other) fashion for map and reduce tasks, respectively.

Selecting different values of Mᵢₙₚ, M_{comp}, and R_{comp} in a round robin or other fashion for each benchmark refers to selecting different values of Mᵢₙₚ, M_{comp}, and R_{comp} to use during execution of the benchmark in a computing platform being considered.

Once the benchmarks are created, the benchmarks can be run on respective platforms to produce platform profiles, as performed at task 204 in FIG. 2. A platform profile includes values of a performance metric (e.g. completion time duration) for respective phases of map and reduce tasks.

Each map task or reduce task includes a sequence of processing phases. Each phase can be associated with a time duration, which is the time involved in completing the phase. The following are example phases of a map task:
Read phase: the read phase reads the input to a map task from a distributed file system. The read phase can read blocks of data, where a block can be of a specified size. However, a map task can also read an entire file or a compressed file. The duration of the read phase is primarily a function of read throughput from the storage subsystem 100.
Map phase: the map phase executes a map function on an input key-value pair. The duration of the map phase depends on processor performance.
Collect phase: the collect phase buffers map phase outputs into memory. The duration of the collect phase is a function of memory bandwidth.
Spill phase: the spill phase locally sorts intermediate data (produced by the map phase) for different reduce tasks, combines intermediate data, and writes intermediate data to local storage. The duration of the spill phase depends on performance of various components, including processor performance and storage access speed of the storage subsystem 100.
Merge phase: the merge phase merges different spill files into a single spill file for each reduce task. The duration of the merge phase depends on storage read and write throughput (of the storage subsystem 100).

A reduce task can include the following phases:
Shuffle phase: the shuffle phase transfers intermediate data from map tasks to reduce tasks and merge-sorts the transferred data. The shuffling and sorting can be combined because these two sub-phases are interleaved. The duration of the shuffle phase primarily depends on network shuffle performance and storage read and write throughput (of the storage subsystem 100).
Reduce phase: the reduce phase applies the reduce function on the input key and all the values corresponding to the input key. The duration of the reduce phase depends on processor performance.
Write phase: the write phase writes the reduce output to the distributed file system in the storage subsystem 100. The duration of the write phase depends on storage write (and possibly network) throughput.

Platform profiles are generated (at 204 in FIG. 2) by running a suite of benchmarks on the computing platforms being compared. While each benchmark is running, the durations of the execution phases of all processed map and reduce tasks can be collected. A set of these measurements defines the platform profile that is used as the training data for the model to be created (task 206 in FIG. 2).

The durations of the eight execution phases listed above (read, map, collect, spill, merge, shuffle, reduce, and write) on each computing platform is collected:
Map task processing: in the platform profiles, the phase durations for respective ones of the read, map, collect, spill, and merge phases are represented as D1, D2, D3, D4, and D5, respectively.
Reduce task processing: in the platform profiles, the phase durations for respective ones of the shuffle, reduce, and write phase are represented as D6, D7, and D8, respectively.

Tables 1 and 2 show portions of a platform profile based on executing a benchmark suite on a computing platform (Table 1 shows the phase durations for map tasks and Table 2 shows the phase durations for reduce tasks):

TABLE 1

| Bench- | Map | Read | Map | Collect | Spill | Merge |
|---|---|---|---|---|---|---|
| mark | Task | msec | msec | msec | msec | msec |
| ID | ID | D1 | D2 | D3 | D4 | D5 |
| 1 | 1 | 1010 | 220 | 610 | 5310 | 10710 |
| 1 | 2 | 1120 | 310 | 750 | 5940 | 11650 |
| . . . | . . . | . . . | . . . | . . . | . . . | . . . |

TABLE 2

| Bench- | Reduce | Shuffle | Reduce | Write |
|---|---|---|---|---|
| mark | Task | msec | msec | msec |
| ID | ID | D6 | D7 | D8 |
| 1 | 1 | 10110 | 330 | 2010 |
| 1 | 2 | 9020 | 410 | 1850 |
| . . . | . . . | . . . | . . . | . . . |

In Table 1, the first column includes an identifier of a benchmark, and the second column includes an identifier of a map task. The remaining columns of Table 1 include phase durations for the phases of map tasks: D1, D2, D3, D4, and D5. The first row of Table 1 contains phase durations for the benchmark with benchmark ID 1, and the map task with map task ID 1. The second row of table 1 contains phase durations for the benchmark with benchmark ID 1, and the map task with ID 2.

Similarly, in Table 2, the first column includes the benchmark ID, and the second column includes the reduce task ID. The remaining columns of Table 2 include phase durations for the phases of reduce tasks: D6, D7, and D8.

Once the platform profiles on the computing platforms to be compared have been derived, a model can be created (task 206 in FIG. 2) using the platform profiles.

In some examples, a model M_{src→tgt} can be created that characterizes the relationship between Map Reduce job executions on two different computing platforms, denoted here as src (source) and tgt (target) computing platforms. In some examples, the source computing platform can be an existing computing platform, and the target computing platform can be a new computing platform. In other examples, both the source and target computing platforms are new alternative computing platforms.

The model creation first finds the relationships between durations of different execution phases on the computing platforms. In some implementations, eight sub-models M₁, M₂, . . . , M₇, M₈ are built that define the relationships for the read, map, collect, spill, merge, shuffle, reduce, and write phases, respectively, on two computing platforms. To build these sub-models, the platform profiles gathered by executing the benchmark suite on the computing platforms being compared are used.

The following describes how to build a sub-model Mᵢ, where 1≦i≦8. By using values from the collected platform profiles, a set of equations is formed that express the duration of each specific execution phase on the target computing platform as a linear function of the same execution phase on the source computing platform. Note that the right and left sides of equations below relate the phase duration of the same task (map or reduce) and of the same microbenchmark on two different computing platforms (by using the task and benchmark IDs):

$${D}_{i , tgt}^{1 , 1} = {A}_{i} + {B}_{i} * {D}_{i , src}^{1 , 1}$$

$${D}_{i , tgt}^{1 , 2} = {A}_{i} + {B}_{i} * {D}_{i , src}^{1 , 2}$$

$$… …$$

$${D}_{i , tgt}^{2 , 1} = {A}_{i} + {B}_{i} * {D}_{i , src}^{2 , 1}$$

$$… …$$

$$… …$$

where D_{i,src}^{j,k} and D_{i,tgt}^{j,k} are the values of metric Dᵢ collected on the source and target platforms, respectively, for the task with ID=j during the execution of benchmark with ID=k.

To solve for (Aᵢ, Bᵢ) in the equations above, i=1 to 8, a linear regression technique can be used, such as a Least Squares Regression technique or another technique.

Let (Âᵢ, \hat{B}ᵢ), i=1 to 8, denote a solution for the set of equations above. Then Mᵢ=(Âᵢ, \hat{B}ᵢ) is the sub-model that describes the relationship between the durations of execution phase i on the source and target platforms. The entire model M_{src→tgt}=(M₁, M₂, . . . , M₇, M₈).

The training dataset (platform profiles) is gathered by the automated benchmark engine 124 that runs identical benchmarks on both the source and target platforms. The non-determinism in MapReduce processing and some unexpected anomalous or background processes, can skew the measurements, leading to outliers or incorrect data points. With ordinary least squares regression, even a few bad outliers can significantly impact the model accuracy, because it is based on minimizing the overall absolute error across multiple equations in the set.

To decrease the impact of occasional bad measurements and to improve the overall model accuracy, an iteratively re-weighted least squares technique can be used. This technique is from the Robust Regression family of techniques designed to lessen the impact of outliers.

Once the model M_{src→tgt} is created, the performance predictor 122 (FIG. 1) can use the model to predict performance of the second computing platform, based on performance of a given MapReduce job (or collection of MapReduce jobs) on the first computing platform. For example, when executing MapReduce job(s) on the first computing platform, measurements of time durations of the various map and reduce task phases can be collected. These durations can be mapped (transformed) to respective time durations of the same phases on the second computing platform, by applying the equations defining sub-models (M₁, M₂, . . . , M₇, M₈).

Machine-readable instructions of various modules described above (including 118, 120, 122, 124 of FIG. 1) are loaded for execution on a processor or processors (such as 116 in FIG. 1). A processor can include a microprocessor, microcontroller, processor module or subsystem, programmable integrated circuit, programmable gate array, or another control or computing device.

Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
determining, by a system having a processor, at least one benchmark that includes a set of parameters and values assigned to the respective parameters;
generating, by the system, platform profiles based on running the at least one benchmark on respective first and second computing platforms; and
creating, by the system based on the generated platform profiles, a model that characterizes a relationship between a MapReduce job executing on the first computing platform and the MapReduce job executing on the second computing platform, wherein the MapReduce job includes map tasks and reduce tasks.

2. The method of claim 1, wherein the map tasks produce intermediate results based on segments of input data, and the reduce tasks produce an output based on the intermediate results.

3. The method of claim 1, wherein each of the platform profiles includes values of a performance metric for respective phases of the map tasks and respective phases of the reduce tasks.

4. The method of claim 3, wherein the performance metric includes a time duration.

5. The method of claim 1, wherein generating the platform profiles comprises collecting measurements relating to phases of the map tasks and reduce tasks during running of the at least one benchmark on the first and second computing platforms.

6. The method of claim 5, wherein the phases of the map tasks include a read phase, a map phase, and a collect phase.

7. The method of claim 6, wherein the phases of each map task further include a spill phase and a merge phase.

8. The method of claim 5, wherein the phases of each reduce task include a shuffle phase, a reduce phase, and a write phase.

9. A system comprising:
at least one processor to:
produce a plurality of benchmarks that describe respective characteristics of MapReduce jobs that include map tasks and reduce tasks;
run the benchmarks on different computing platforms;
collect measurements relating to map tasks and reduce tasks during running the benchmarks; and
create a model based on the collected measurements, wherein the model characterizes a relationship between MapReduce job execution on a first one of the computing platforms with MapReduce job execution on a second one of the computing platforms.

10. The system of claim 9, wherein the first computing platform is an existing computing platform on which production MapReduce jobs are executed, and the second computing platform is a new computing platform for replacing the existing computing platform.

11. The system of claim 9, wherein the first and second computing platforms are alternative computing platforms considered for selection.

12. The system of claim 9, wherein the model is created based on using linear regression based on the measurements.

13. The system of claim 9, wherein the model includes sub-models that make up the model, wherein each of the sub-models relates a phase of a map task or reduce task on the first computing platform to a corresponding phase of a map task or reduce task on the second computing platform.

14. The system of claim 9, wherein the benchmarks are produced using a benchmark specification that includes parameters and collections of candidate values of the corresponding parameters, wherein each of the parameters relates to a characteristic of a map task or reduce task.

15. The system of claim 14, wherein the benchmarks produced using the benchmark specification are based on using different ones of the candidate values of the collection of values associated with at least one of the parameters in the benchmark specification.

16. The system of claim 9, wherein each of the benchmarks includes a map selectivity parameter that represents a ratio of a size of a map task output to a size of map task input.

17. The system of claim 16, wherein each of the benchmarks further includes a reduce selectivity parameter that represents a ratio of a size of a reduce task output to a size of a reduce task input.

18. The system of claim 17, wherein each of the benchmarks further includes a map computation parameter that represents computation performed by a map task, and a reduce computation parameter that represents computation performed by a reduce task.

19. The system of claim 9, wherein the measurements include durations of respective phases of map tasks and respective phases of reduce tasks.

20. An article comprising at least one machine-readable storage medium storing instructions that upon execution cause a system having a processor to:
determine at least one benchmark that represents characteristics of map and reduce tasks;
generate platform profiles based on running the at least one benchmark on respective first and second computing platforms, wherein the platform profiles includes values of at least one performance metric for respective phases of map tasks and respective phases of reduce tasks; and
create, based on the generated platform profiles, a model that characterizes a relationship between a MapReduce job executing on the first computing platform and the MapReduce job executing on the second computing platform, wherein the MapReduce job includes map tasks and reduce tasks.
